(19) United States
(12) Patent Application Publication
(10) Pub. No.: US 2009/0142606 A1
(43) Pub. Date: Jun. 4, 2009

(54) METHOD FOR PREPARING RETICULATED ORGANIC COATINGS ON A BASE

(75) Inventor: Christian Mirou, Lyon (FR)

Correspondence Address: Baker Donelson Bearman, Caldwell & Berkowitz, PC, 555 Eleventh Street, NW, Sixth Floor, Washington, DC, 20004, US

(73) Assignee: Bluestar Silicones France, Lyon Cedex 03 (FR)

(21) Appl. No.: 12/067,020

(22) PCT Filed: Sep. 13, 2006
(86) PCT No.: PCT/EP2006/066329

§ 371 Date: Aug. 12, 2008

(30) Foreign Application Priority Data
Sep. 16, 2005 (FR) 05 09482

(51) Int. Cl. C08F 2/48; B32B 29/06; B32B 27/32; B32B 27/36

(52) U.S. Cl. 428/457; 522/170; 522/184; 522/182; 522/168; 522/169; 522/31; 428/537.5; 428/500; 428/523; 428/480

(57) ABSTRACT

A process for the polymerization and/or crosslinking of an organic coating composition is provided. The process involves employing an organic coating composition which can crosslink and/or polymerize under irradiation with short-wave ultraviolet (UV C) radiation with a wavelength of between 200 and 280 nm.

The present invention relates to a novel process for the polymerization and/or crosslinking of an organic coating composition. In particular, it relates to the preparation of a crosslinked organic coating on a support under irradiation with short-wave ultraviolet (UV-C) radiation. These coatings are particularly suited for their use in the field of adhesives, protective varnishes, lacquers, inks and paints.

One of the surface treatment techniques widely used in the field of adhesives, protective varnishes, lacquers, inks and paints is the technique referred to as “UV curing”.

This technique is widely used as it confers novel surface properties on the material while retaining the starting properties of the base material (substrate) and while providing physical continuity.

The “UV curing” technology represents a surface treatment technology which uses electromagnetic radiation (UV radiation) to bring about chemical and physical changes at the surface of organic materials (base materials or substrates) by the formation of crosslinked polymer networks.

This technology is widespread, in particular for conversion products capable of curing (crosslinking) with UV radiation, such as adhesives, protective varnishes, lacquers, inks and paints. This is because, in comparison with conventional products based on organic and aqueous solvents, these products exhibit advantages at the technical level (rapid crosslinking and less material shrinkage).

In practice, it is the light energy of UV radiation which makes possible the formation of the active players, by radical cleavage, and thus the triggering and the continuation of the crosslinking and/or polymerization.

The majority of the products which crosslink by UV radiation are radical systems. In addition to the base chemical constituents, such as a prepolymer, a reactive diluent and additives, the formulation comprises a photoinitiator. This photoinitiator, under the action of the UV radiation, generates free radicals which will initiate the radical polymerization reactions.

Generally, irradiating is carried out under UV radiation with a wavelength of between 100 and 400 nano-meters. The UV lamps commonly used are known as high-pressure mercury vapor UV lamps. They are electric arc lamps which bring about the excitation of the mercury atoms and then the emission of radiation when returning to their ground state. High-pressure UV lamps operate at internal pressures of greater than 2 bar and an arc power of the order of 80 to 240 W/cm, with is reflected, taking into account the low degree of conversion to UV-C radiation, by UV-C powers of the order of 2 to 10 W/cm.

An arc high-pressure mercury vapor lamp comprises a burner (which generates light), a reflector and terminals. The burner is composed of a hollow quartz tube sealed at both ends which is filled with a starting gas and a trace of mercury. The metal electrodes pass through the ends of the sealed tube and form a small air gap for the arc. During operation, a voltage peak is applied to the electrodes in order to produce a spark in the starting gas and to vaporize the mercury. Once this spark has been initiated in the gas, a current passes through the gas at a lower voltage to generate the optical power.

There also exists a second type of high-pressure mercury vapor lamp which uses, in place of the electrodes, a system comprising a microwave supply instead of a high voltage supply. The microwaves are generated by magnetrons placed behind a reflector and provide the energy necessary to ionize the mercury. These lamps have the same appearance as the preceding lamps, apart from the absence of electrodes and a narrower tube diameter.

The dispersion spectrum of the light generated by these UV lamps is not limited to the region of short-wave ultraviolet radiation (UV-C) and extends even into the visible region (emission of a polychromatic spectrum). In practice, a large amount of energy is lost by production of heat.

Current UV technologies for polymerization, although functioning, have a number of disadvantages due to the nature of the lamps used:
the heat given off by these lamps is high (temperature under the lamp of the order of 900° C.),
significant generation of ozone occurs, and
the technology is complex to employ, in particular with regard to the electrical supply system (approximately 380 V) and with regard to the cooling system for these lamps, which is rather bulky and unwieldy, which necessitates high capital costs and a relatively high operating cost.

Thus, one objective of the present invention is to develop a new process for the polymerization and/or crosslinking of an organic coating composition which no longer exhibits the abovementioned disadvantages.

In order to achieve this objective, the inventors have had the credit of demonstrating, entirely surprisingly and unexpectedly, that the use of at least one low-pressure lamp emitting, in the short-wave ultraviolet (UV-C) region, a quasimonochromatic light makes it possible to polymerize, on a support, an organic coating composition which can crosslink and/or polymerize under irradiation with radiation of short-wave ultraviolet type, this being the case even at industrial rates of continuous coating (up to 600 m/min, indeed even more). Short-wave ultraviolet radiation covers the spectral region between 200 and 280 nm.

This is noteworthy in every respect as low-pressure lamps are known to exhibit arc powers of approximately:
0.5 W/cm in UV-C radiation for a standard low-pressure mercury vapor lamp (electrical power at the input: approximately 60 W), and
2 W/cm in UV-C radiation for a low-pressure amalgam lamp (electrical power at the input: approximately 300 W).

However, in normal practice, medium- or high-pressure mercury vapor lamps with high arc powers, which are of the order of 80 to 240 W/cm for high-pressure vapor lamps (electrical power at the input of the order of 14000 W), are employed for continuous coating applications.

Furthermore, low-pressure vapor lamps, due to their low irradiation powers in the UV-C region, are mainly used in the field of the disinfection of water. The technique consists in subjecting the water to be treated to a source of UV-C radiation while causing it to pass through a channel comprising a series of submerged lamps. In any case, in view of their technical characteristics, these low-pressure vapor lamps have been used only in the field of water treatment, which requires a low UV-C irradiation power.

For these various reasons, the use of low-pressure vapor lamps in the preparation of an organic coating by polymerization and/or crosslinking on a support has remained subject to an unfavorable preconception by a person skilled in the art.

The invention provides a solution which makes it possible both to overcome the above-mentioned preconception and to solve the specific problems presented by the production of an organic coating on a support.

A second objective of the present invention is to develop a new process for the preparation of a crosslinked organic coating on a support under irradiation with short-wave ultraviolet (UV-C) radiation.

A first subject-matter of the invention is thus a process for the polymerization and/or crosslinking of an organic coating composition, comprising the following stages:
a) the preparation of an organic coating composition, which can crosslink and/or polymerize under irradiation with short-wave ultraviolet (UV-C) radiation with a wavelength of between 200 and 280 nm, and
c) the irradiating of said composition with at least one low-pressure lamp which emits a quasimonochromatic light in the UV-C region, so as to polymerize and/or crosslink said composition.

According to a particularly advantageous embodiment, an additional stage b), which comprises the coating of said organic coating composition on a support, is carried out between stage a) and c).

According to a preferred embodiment, the support is of paper, polyethylene, polypropylene or polyester type.

According to another preferred embodiment, the coated support is heated, during and/or after stage c), at a temperature of at least 40° C. and preferably of between 40° C. and 170° C.

A person skilled in the art, after having become acquainted with the present invention, will appreciate, in such-and-such a context, the advantages of the present invention over the techniques of the prior art mentioned above. There may already be emphasized here the effectiveness of the process of the invention and the limited unwieldiness of the equipment necessary for its implementation. Mention may also be made of the following advantages:
the heat given off by these lamps is low (temperature at the surface of the lamp is of the order of 40 to 50° C.),
the generation of ozone is suppressed,
the technology is simple and more economic to employ,
the coatings obtained are odorless, and
the disbondment force for the coating obtained after crosslinking is of comparable quality to that obtained via a conventional process.

It is thus apparent that the process according to the invention is altogether noteworthy as regards the profitability and the saving which it brings about when it is used industrially.

There exist two types of low-pressure UV-C lamp of use according to the invention: low-pressure vapor lamps, in particular low-pressure mercury vapor lamps, and low-pressure amalgam lamps (gold, silver, mercury and iridium mixture).

Low-pressure amalgam lamps exhibit the advantage of providing 3 to 5 times more UV-C energy than a conventional low-pressure mercury vapor emitting lamp for the same level of electrical energy. Low-pressure amalgam lamps exhibit UV-C irradiating powers of the order of 2 W/cm for an operating electrical power of approximately 300 W.

Low-pressure mercury vapor lamps emit a quasimonochromatic light at 253.7 nm through a quartz tube. This quartz tube (casing of the lamp) acts as filter from 185 nm, which thus limits the creation of ozone.

They are provided in the form of long tubes with a diameter of 1.5 to 2 cm. The intensity transmitted depends on the voltage, on the temperature around the lamp and on its age (low-pressure lamps have a lifetime of approximately 8000 hours). They exhibit UV-C irradiating powers of the order of 0.2 W/cm for an operating electrical power of approximately 60 W.

According to the process of the invention, it is advantageous for the low-pressure vapor lamps, in particular the low-pressure mercury vapor lamps, to be in an environment (or a chamber) where the temperature is maintained between 20 and 70° C., preferably between 30 and 65° C. and more preferably still between 35 and 55° C.

This is because, for low-pressure mercury vapor lamps, the temperature influences the pressure which can be maintained in the lamp. Too low, it brings about a fall in pressure, the mercury atoms are less compressed therein and thus more difficult to excite, and thus results in a decrease in the amount of electricity converted. Conversely, an increase in the temperature will increase the pressure, the excitation of the electrons of the mercury atoms will be greater but the light energy will be released in a much broader spectrum than 253.7 nm (this is in particular the case with high- and medium-pressure lamps).

The number of low-pressure vapor lamps is chosen according to the rate of coating and the organic formulation to be polymerized.

There exist numerous manufacturers of low-pressure mercury vapor lamps; mention may be made, for example, of the lamps sold by Philips of TUV, TUV PL-S or TUV PL-L type (electrical power of 18 to 60 W), in particular UV lamps of TUV PL-L type (electrical power of 60 W).

The irradiating time can be short, that is to say less than 1 second and of the order of a few tenths of a second for thin coatings. The curing time is regulated:
(a) by the number of UV lamps used,
(b) by the duration of exposure to the UV-C radiation and/or
(c) by the distance between the composition and the UV lamp.

The amounts of coating deposited on the supports can vary. The speed of forward progression of the support can vary and can reach speeds of the order of 600 m/min, and even more.

The compositions are applied using devices capable of uniformly depositing small amounts of liquids.

Use may be made, to this end, for example, of the device referred to as “Helio glissant” comprising in particular two superimposed rolls: the function of the lowermost roll, immersed in the coating tank comprising the composition, is to impregnate, in a very thin layer, the uppermost roll; the function of the latter is then to deposit, on the support, the desired amounts of composition with which it is impregnated; such a dosage is obtained by adjusting the respective speed of the two rolls, which rotate in opposite directions with respect to one another.

Use may also be made of devices known under the name of “multiroll coating heads” (4, 5 or 6 rolls) in which the deposition is adjusted by adjusting the differen-tial rotation speeds between the rolls.

The amounts of organic coating generally range between 0.1 and 5 g/m² of treated surface. The amounts depend on the nature of the supports.

The supports can be a metal material, such as a tin-plate, preferably a cellulose material of paper or board type, for example, or a polymer of vinyl type. Thermoplastic polymer films, such as polyethylene, polypropylene or polyester, are particularly advantageous, for example supports of poly(ethylene terephthalate) (PET) type.

According to one embodiment of the invention, said organic coating composition which can crosslink and/or polymerize under irradiation with ultraviolet-C (UV-C) radiation with a wavelength of between 200 and 280 nm comprises:
(a) at least one organic crosslinkable and/or polymerizable monomer, oligomer and/or polymer A carrying at least one functional group Fa which can crosslink and/or polymerize by the cationic or radical route, and
(b) an effective amount of at least one cationic photoinitiator or of at least one radical photoinitiator active under UV-C radiation, in particular composed of at least one onium borate.

Said organic coating composition can be provided in the form of a liquid or of a gel.

According to a preferred form of the invention, the functional group Fa which can crosslink and/or polymerize by the cationic route is chosen from the group consisting of alkenyl, epoxy (meth)acrylate, alkenyloxy, oxetane, urethane and/or dioxolane functional groups.

As regards the crosslinkable and/or polymerizable organic monomers, oligomers and/or polymers A carrying at least one functional group Fa which can crosslink and/or polymerize by the cationic route, mention may be made of the following organic molecules:
mono-, di- or polyacrylates and -methacrylates, such as methyl acrylate, methyl methacrylate, ethyl acrylate, isopropyl methacrylate, n-hexyl acrylate, stearyl acrylate, allyl acrylate, glycerol diacrylate, glycerol triacrylate, ethylene glycol diacrylate, diethylene glycol diacrylate, triethylene glycol dimethacrylate, 1,3-propanediol diacrylate, 1,3-propanediol dimethacrylate, trimethylolpropane triacrylate, 1,2,4-butanetriol trimethacrylate, 1,4-cyclo-hexanediol diacrylate, pentaerythritol triacrylate, pentaerythritol tetraacrylate, pentaerythritol tetra-methacrylate, sorbitol hexaacrylate, bis[1-(2-acryloxy)]-p-ethoxyphenyldimethylmethane, bis[1-(3-acryloxy-2-hydroxy)]-p-propoxyphenyldimethylmethane, tris(hydroxyethyl)isocyanurate trimethacrylate, bis-acrylates and bismethacrylates of polyethylene glycol with molecular weights of between 200 and 500 g/mol, mixtures of acrylic monomers, such as those described in U.S. Pat. No. 4,652,274, and the acrylic oligomers described in U.S. Pat. No. 4,642,126;
unsaturated amides, such as methylenebisacrylamide, methylenebismethacrylamide, 1,6-hexamethylenebisacryl-amide, diethylenetriaminetrisacrylamide and 5-(β-methacrylaminoethyl),methacrylate;
vinyl derivatives, such as styrene, diallyl phthalate, divinyl succinate, divinyl adipate, divinyl phthalate, isobutylene, butadiene, isoprene, methyl-styrene, divinylbenzenes, N-vinylpyrrolidone, N-vinyl-carbazole and acrolein;
vinyl ethers, for example methyl vinyl ether, isobutyl vinyl ether, trimethylolpropane trivinyl ether and ethylene glycol divinyl ether; cyclic vinyl ethers;
ethylene oxide, propylene oxide, epichlorohydrin, n-butyl glycidyl ether, n-octyl glycidyl ether, phenyl glycidyl ether or cresyl glycidyl ether;
epoxy resins, such as 1,2-, 1,3- and 1,4-cyclic ethers (known as 1,2-, 1,3- and 1,4-epoxy). The reference “Encyclopedia of Polymer Science and Technology”, 6, (1986), p. 322, describes numerous epoxy resins suitable for the present invention. Mention may be made, for example, of the commercial products denoted under the name “ERL®”, supplied by Dow Chemical, vinylcyclohexene oxide, vinylcyclohexene dioxide (“ERL 4206®”), 3,4-epoxy-6-methylcyclohexyl-methyl 3,4-epoxy-6-methylcyclohexenecarboxylate (“ERL 4201®”), bis(2,3-epoxycyclopentyl)ether (“ERL 0400®”), 3,4-epoxycyclohexylmethyl 3,4-epoxycyclohexane-carboxylate (“ERL 4221®”), bis(3,4-epoxycyclohexyl) adipate (“ERL 4289®”), aliphatic epoxy compounds derived from polypropylene glycol (“ERL 4050®” and “ERL 4052®”), dipentene dioxide (“ERL 4269®”), 2-(3,4-epoxycyclohexyl-5,5-spiro-3,4-epoxy)cyclohexene-meta-dioxane (“ERL 4234®”), epoxy resins of glycidyl ether type, such as propylene oxide, epichlorohydrin, styrene oxide, glycidol, epoxy resins available commercially under the name “EPON®” supplied by Shell Chemical Co., “EPON 828®”, “EPON 1001®”, “EPON 1004®”, “EPON 1007®”, “EPON 1009®” and “EPON 2002®”; dicyclopentadiene dioxide, epoxidized vegetable oils, such as those sold under the “VIKOLOX®” and “VIKOFLEX®” names, supplied by Elf Atochem North America Inc., liquid epoxidized polymers, available commercially under the name “KRATON®”, such as the product “L-207®” sold by Shell Chemical Co.; epoxidized polybutadienes, such as those sold under the name “POLY BD®”, supplied by ElfAtochem; 1,4-butanedioldiglycidyl ether, phenol/formaldehyde polyglycidyl ether; epoxidized phenolic novolac resins, such as those available commercially under the name “DEN 431®” and “DEN 438®” supplied by Dow Chemical Co.; the products sold commercially under the name “ARALDITE ECN 1299®” by Vantico Inc.; resorcinol diglycidyl ether; epoxidized polystyrene/polybutadiene blends, such as those available commercially under the name “EPOFRIEND®”, such as the product “EPOFRIEND A1010®”, from Daicel USA Inc.; the alkyl glycidyl ether derivatives sold commercially under the name “HELOXY®” by Shell Chemical Co., such as C₈-C₁₀ alkyl glycidyl ethers (“HELOXY MODIFIER 7®”), C₁₂-C₁₄ alkyl glycidyl ethers (product “HELOXY MODIFIER 8®”), butyl glycidyl ether (product “HELOXY MODIFIER 61®”), cresyl glycidyl ether (product “HELOXY MODIFIER 62®”), p-(tert-butyl)-phenyl glycidyl ether (product “HELOXY MODIFIER 65®”), polyfunctional glycidyl ethers, such as 1,4-butanediol diglycidyl ether (product “HELOXY MODIFIER 67®”), neopentyl glycol diglycidyl ether (“HELOXY MODIFIER 68®”), cyclohexanedimethanol diglycidyl ether (“HELOXY MODIFIER 107®”), trimethylolethane triglycidyl ether (“HELOXY MODIFIER 44®”), trimethylolpropane triglycidyl ether (“HELOXY MODIFIER 48®”), the polyglycidyl ether of an aliphatic polyol (“HELOXY MODIFIER 84®”), polyglycol diepoxide (“HELOXY MODIFIER 32®”), and bisphenol F epoxides.

Polymerization and/or crosslinking by photoactivation is generally initiated in the presence of a photoinitiator, including a radical photoinitiator, incorporated in the organic composition.

A person skilled in the art would be able, without any difficulty, to choose an appropriate radical photoinitiator (λₘₐₓ<280 nm) which can optionally be used in combination with a photosensitizer in order to render the photocatalytic system active under the wavelength of the UV-C lamp used according to the invention.

Mention will in particular be made, as examples of radical photoinitiator, of the following products: 9-xanthenone, 1,4-dihydroxyanthraquinone, anthraquinone, 2-methylanthraquinone, 2,2′-bis(3-hydroxy-1,4-naphthoquinone), 2,6-dihydroxyanthraquinone, 1-hydroxycyclohexyl phenyl ketone, 1,5-dihydroxyanthraquinone, 1,3-diphenyl-1,3-propanedione, 5,7-dihydroxy-flavone, dibenzoyl peroxide, 2-benzoylbenzoic acid, 2-hydroxy-2-methylpropiophenone, 2-phenylacetophenone, 2,4,6-trimethylbenzoyldiphenylphosphine oxide, anthrone, bis(2,6-dimethylbenzoyl)(2,4,4-trimethylpentyl)-phosphine oxide, poly[1,4-benzenedicarbonyl-alt-bis-(4-phenoxyphenyl)methanone].

Preferably, the radical photoinitiator or photoinitia-tors will be chosen form the group consisting of: 4,4′-dimethoxybenzoin; phenanthrenequinone; 2-ethylanthraquinone; 2-methylanthraquinone; 1,8-dihydroxyanthraquinone; dibenzoyl peroxide; 2,2-dimethoxy-2-phenylacetophenone; benzoin; 2-hydroxy-2-methylpropiophenone; benzaldehyde; 4-(2-hydroxyethoxy)phenyl 2-hydroxy-2-methylpropyl ketone;

benzoylacetone; and their mixture.

Mention may be made, as examples of commercial radical photoinitiator products, of the products sold by Ciba-Geigy: Irgacure 369®, Irgacure 651®, Irgacure 907®, Darocure 1173®, and the like.

Conventionally, during crosslinking under UV-C radiation by a photoinitiator, generally a cationic photoinitiator, the latter releases a strong acid under irradiation. It catalyzes the cationic polymerization reaction of the functional groups.

It is understood that any cationic photoinitiator active under UV-C radiation may be suitable according to the invention and that a person skilled in the art will be able, without any difficulty, to choose a cationic photoinitiator active under UV-C radiation.

Mention may be made, as example of cationic photoinitiator active under UV-C radiation, without implied limitation, of onium borates. According to a first preferred alternative form of the invention, the types of the borate anionic entity which are very particularly suitable are as follows:

### 1′: [B (C₆F₅)₄]⁻ 5′: [B (C₆H₃ (CF₃)₂)₄]⁻

### 2′: [(C₆F₅)₂BF₂]⁻ 6′: [B (C₆H₃F₂)₄]⁻

### 3′: [B (C₆H₄CF₃)₄]⁻ 7′: [C₆F₅BF₃]⁻

### 4′: [B (C₆F₄OCF₃)₄]⁻

According to a second preferred alternative form of the invention, the onium salts which can be used are described in numerous documents, in particular in patents U.S. Pat. No. 4,026,705, U.S. Pat. No. 4,032,673, U.S. Pat. No. 4,069,056, U.S. Pat. No. 4,136,102, U.S. Pat. No. 4,173,476 and EP 562 897. Among these, preference will very particularly be given to the following cations:

### [(Φ-CH₃)₂I]⁺ [(C₈H₁₇—O-Φ)₂I]⁺

### [(C₁₂H₂₅-Φ)₂I]⁺ [CH₃-ΦI-Φ-C₁₂H₂₅]⁺ [(HO—CH₂—CH₂)₂S—CH₂-Φ)]⁺

### [(C₁₂H₂₅—CH(OH)—CH₂—O-Φ)₂]⁺

### [(HO—CH₂—CH₂—O-Φ)₃S]⁺ [(HO—CH₂—CH₂—O-Φ)₂—S-Φ-O—C₈H₁₇]⁺

### [CH₃-Φ-I-Φ-CH(CH₃)₂]⁺ and [(CH₃)₃C-Φ-I-Φ-C(CH₃)₃]⁺

In agreement with these two preferred alternative forms, mention may be made, as examples of photoinitia-tors of the onium borate type, of the following products:

### [(C₁₂H₂₅—CH(OH)—CH₂—O-Φ)₂I]⁺ [B(C₆F₅)₄]⁻

### [(C₈H₁₇—O-Φ)₂I]⁺ [B (C₆F₅)₄]⁻

### [(CH₃)₃C-Φ-I-Φ-C(CH₃)₃]⁺ [B(C₆F₅)₄]⁻

### [(C₁₂H₂₅-Φ)₂I]⁺ [B(C₆F₅)₄]⁻

### [(Φ-CH₃)₂I]⁺ [B(C₆F₅)₄]⁻

### [(Φ-CH₃)₂I]⁺ [B(C₆F₄OCF₃)₄]⁻

### [CH₃-Φ-I-Φ-CH(CH₃)₂]⁺ [B(C₆F₅)₄]⁻

### [(HO—CH₂—CH₂)₂S—CH₂-Φ]⁺ [B (C₆F₅)₄]⁻

### [CH₃-Φ-I-Φ-CH(CH₃)₂]⁺ [B(C₆H₃(CF₃)₂)₄]⁻

### and [(C₁₂H₂₅Φ)₂I]⁺ [B(C₆H₃(CF₃)₂)₄]⁻

This initiator is, of course, present in an amount sufficient and effective to activate the photopolymerization and/or crosslinking.

The term “effective amount of initiator” is understood to mean, according to the invention, the amount sufficient to initiate the polymerization and/or the crosslinking. This amount is generally between 0.001 and 1 part by weight, more often between 0.005 and 0.5 part by weight, in order to polymerize and/or crosslink 100 parts by weight of the organic coating composition.

The final subject-matter of the invention is the use of at least one low-pressure lamp which emits, in the UV-C region, a quasimonochromatic light in the preparation of a crosslinked organic coating on a support.

1. A process for the polymerization and/or crosslinking of an organic coating composition, comprising the following stages:
a) the preparation of an organic coating composition which can crosslink and/or polymerize under irradiation with short-wave ultraviolet (UV-C) radiation with a wavelength of between 200 and 280 nm, and
c) the irradiating of said composition with at least one low-pressure lamp which emits a quasimonochromatic light in the UV-C region, so as to polymerize and/or crosslink said composition.

2. The process as claimed in claim 1, in which an additional stage b), which comprises the coating of said organic coating composition on a support, is carried out between stage a) and c).

3. The process as claimed in claim 1, in which the low-pressure lamp is a low-pressure mercury vapor lamp.

4. The process as claimed in claim 1, in which the low-pressure lamp is a low-pressure amalgam lamp.

5. The process as claimed in claim 1, in which the low-pressure vapor lamp is in a chamber having a temperature maintained between 20 and 70° C.

6. The process as claimed in claim 1, in which:
the coated support is heated, during and/or after stage c), at a temperature of at least 40° C.

7. The process as claimed in claim 1, in which said organic coating composition which can crosslink and/or polymerize under irradiation with ultraviolet-C (UV-C) radiation with a wavelength of between 200 and 280 nm comprises:
(a) at least one organic crosslinkable and/or polymerizable monomer, oligomer and/or polymer A comprising at least one functional group Fa which can crosslink and/or polymerize by a cationic or radical route, and
(b) an effective amount of at least one cationic photoinitiator or of at least one radical photoinitiator active under UV-C radiation.

8. The process as claimed in claim 6, in which the functional group Fa is selected from the group consisting of alkenyl, epoxy, acrylate, alkenyloxy, oxetane and dioxolane.

9. The process as claimed in claim 2, in which the support comprises paper, polyethylene, polypropylene and/or polyester.

10. A method for the preparation of a crosslinked organic coating on a support comprising employing at least one low-pressure lamp which emits, in the UV-C region, a quasimonochromatic light.

11. A method of claim 7 wherein the photoinitiator comprises at least one onium borate.

12. A method of claim 6, wherein the temperature is from 40-170 C.

13. A method of claim 5, wherein the temperature is from 30 to 65° C.

14. A method of claim 5, wherein the temperature is from 35 to 55° C.

15. A support coated with an organic coating composition which can crosslink and/or polymerize under irradiation with short-wave ultraviolet (UV-C) radiation with a wavelength of between 200 and 280 nm.
